(19) United States
(12) Patent Application Publication
(10) Pub. No.: US 2008/0263436 A1
(43) Pub. Date: Oct. 23, 2008

(54) METHODS AND APPARATUS TO REACH THROUGH TO BUSINESS LOGIC SERVICES

(76) Inventors: Mark H. Ahrens, Milford, CT (US); David S. Dyson, Vincentown, NJ (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/030,722

(22) Filed: Feb. 13, 2008

Related U.S. Application Data
(60) Provisional application No. 60/889,701, filed on Feb. 13, 2007.

(51) Int. Cl. G06F 17/00; G06F 9/54

(52) U.S. Cl. 715/234; 719/313

(57) ABSTRACT

Methods and systems to reach through to business logic services are disclosed. An example method involves receiving a report request from a portal and building context information based on the request. Additionally, the example method includes generating context extensible markup language (XML) associated with the context information, assigning a context identifier to the context XML, and returning the context identifier to the portal for forwarding to the business intelligence application to initiate a service associated with the context information.

### RELATED APPLICATIONS

This patent claims the benefit of U.S. provisional application Ser. No. 60/889,701, filed on Feb. 13, 2007, which is hereby incorporated by reference herein in its entirety.

### FIELD OF THE DISCLOSURE

This disclosure relates generally to service oriented architecture (SOA) systems, and, more particularly, to methods and apparatus to reach through to business logic services.

### BACKGROUND

Market data analysis techniques are often essential to making development and planning decisions in many businesses. Businesses often use data analysis software from internal applications and/or one or more external applications to perform different types of market analyses. To specify particular analyses or to retrieve analysis results from a data source, the data analysis software often provides a custom-tailored interface written specifically for the one or more external applications that may employ foreign executable commands and/or operate on disparate platform(s). Additionally or alternatively, the external application provider may require labor-intensive software development to permit use of its resources (e.g., business analysis algorithms, database(s), etc.).

### BRIEF DESCRIPTION OF THE DRAWINGS

FIG. 1 is a schematic illustration of an example system to reach through to business logic services.

FIGS. 2 and 3 are more detailed schematic illustrations of two example manners of implementing the example system of FIG. 1 to reach through to business logic services.

FIGS. 4A and 4B are flowcharts representative of example machine readable instructions which may be executed to implement the examples systems of FIGS. 1-3.

FIG. 5 depicts an example graphical user interface of an application used to retrieve report information from a plurality of separate data sources without requiring a user to repeatedly provide selection criteria indicative of the information to be retrieved.

FIG. 6 is a block diagram of an example system configured to retrieve information from a plurality of data sources.

FIG. 7 is an example table of contents that may be used to implement the table of contents of FIG. 6.

FIG. 8 depicts an example table of contents written in an extensible markup language (XML) that may be used to implement the example table of contents of FIG. 7.

FIG. 9 depicts an example mapping table format that may be used to implement the mapping table of FIG. 6.

FIG. 10 is an example mapping table data structure implemented in accordance with the example mapping table format of FIG. 9.

FIG. 11 is an example timing diagram representative of example communication transactions between entities of the example system of FIG. 6.

FIG. 12 is a flowchart representative of example machine readable instructions that may be executed by one or more entities of the example system of FIG. 6 to enable the information retrieval application of FIG. 5 to retrieve information from a plurality of separate data sources without requiring a user to repeatedly provide selection criteria indicative of the information to be retrieved.

FIG. 13 is a block diagram of an example processor system that may be used to execute the example machine readable instructions of FIGS. 4A, 4B, and 8 to implement the example systems, apparatus, and/or methods described herein.

### DETAILED DESCRIPTION

Generally speaking, a service oriented architecture (SOA) is a software architecture that enables use of loosely coupled software services/applications to support one or more requirements of, for example, a business and/or disjoint process. Such applications are typically resources on a network (e.g., an intranet and/or the Internet) that may be made available as independent services to users, but they may be made available via other non-networked approaches. The users may include, but are not limited to, users within a single corporate entity and/or users that operate within contract parameters to access and/or use the application(s). To implement such an SOA, software developers may construct a portal (e.g., an interface for accessing various services/applications) that utilizes or provides access to one or more other applications, thereby allowing the user(s) to retrieve results (e.g., based on queries). The applications invoked by the users may operate in a transparent manner such that, for example, the users may not know and/or care that the invoked applications are external to their organization.

Interacting with such loosely coupled and/or disjoint software services results in an environment where inter-operation between the various services occurs without a common underlying platform and/or programming language. While the portal appears as a seamless interface for the users, programming efforts to enable access to such disparate services are labor intensive and require generation of highly customized code.

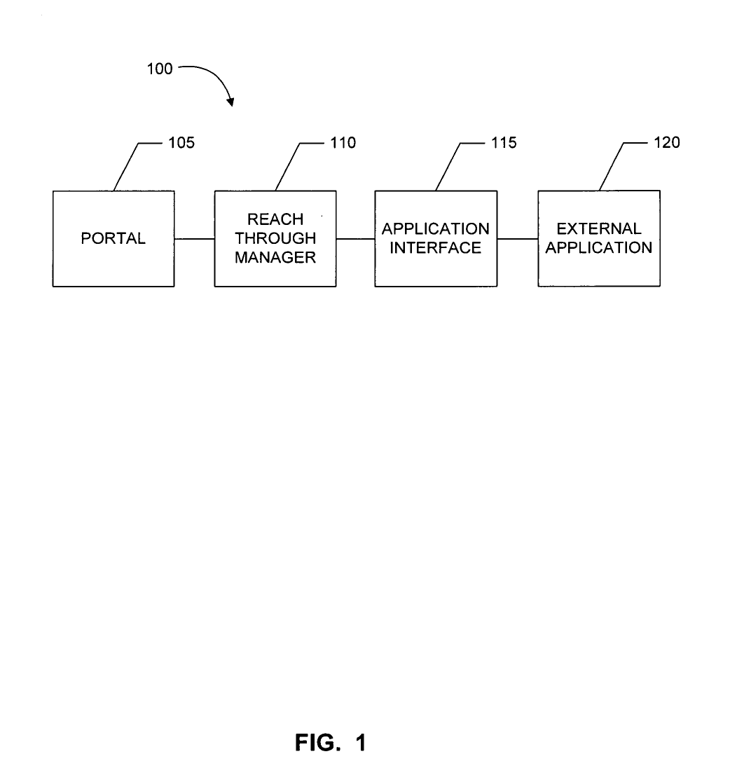

FIG. 1 is a high-level schematic illustration of an example system 100 to reach through to business logic data (e.g., one or more databases) and/or services, such as an external application. In the illustrated example of FIG. 1, a portal 105 employs web-based services to render one or more reports to a user. The example portal 105 may operate under the control of a user and/or organization, and may provide access to and/or consolidate report results from disparate applications within an organization, and/or external to the organization (e.g., a corporate entity, a partnership, a business, etc.). While the example portal 105 may operatively connect with one or more networks within the organization to assist the user with business intelligence initiatives, the example portal 105 of FIG. 1 is also operatively connected to an example reach through manager 110 to facilitate connectivity with one or more external (hereinafter “external” or “nonnative”) applications and/or services. As discussed in further detail below, the example reach through manager 110 may operate in a manner transparent to the user, such that requesting, building, and/or receiving reports is achieved as if the external application(s) were locally available.

In the illustrated example, the reach through manager 110 is communicatively connected to an application interface 115 to allow access to an external application 120 without a need to reprogram the external application 120 for specific requirements of the user. As described above, external application(s) 120 may be, for example, owned and/or operated by one or more independent third parties (e.g., an entity with data mining expertise). Various businesses, corporations, and/or other market players may find significant value in such an external application 120 and desire to utilize its capabilities (e.g., obtain information available through the external application). Given the wide variety of persons and/or devices attempting to access these resources, developers of an example third party external application 120 (and/or an internal application) may find it onerous and/or practically impossible to develop custom code for each potential user platform so that each such user platform (e.g., UNIX, PC, SQL, proprietary interface, etc.) operates seamlessly with the external application 120. To address these concerns, the example system of FIG. 1 includes the application interface 115. The example application interface 115 minimizes and/or eliminates custom programming of the third party external application 120. In the illustrated example, the application interface 115 is implemented as a web service hosted as an extension to the external application 120. The application interface 115 may be developed in any programming language without limitation, such as, for example, Java, Javascript, etc. The application interface 115 may allow pre-existing and/or third party external application services to be consumed with minimal changes to the external application. Additionally, the application interface 115 may be incorporated into native applications within an organization to allow utilization of services by the one or more external applications 120.

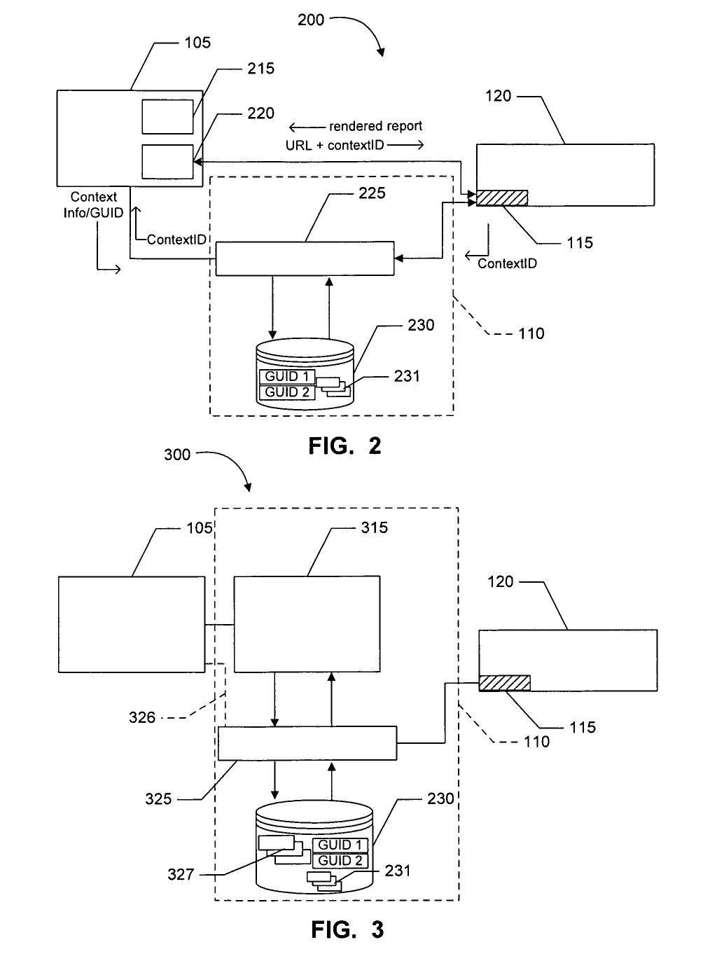

FIG. 2 is a schematic illustration of an example system 200 to implement the example system 100 to reach through to an external application of FIG. 1. While the example system 200 of FIG. 2 illustrates only a single example portal 105 and a single example external application 120, multiple portals 105 and/or multiple applications 120 may operate in the example SOA of FIG. 2. Further, because FIG. 2 illustrates an example manner of implementing the system 100 of FIG. 1, some structure of FIG. 1 appears in FIG. 2. Similar items are labeled with similar reference numbers in FIGS. 1 and 2.

As discussed above in connection with FIG. 1, the example portal 105 of FIG. 2 employs networked (e.g., web-based) services to render one or more reports to a user. The portal 105 may operate under the control of a user employed, for instance, by a corporate entity and may consolidate report results from disparate applications within and/or external to, that corporate entity. In the illustrated example of FIG. 2, the portal 105 includes a first frame or window 215 to display, for example, market forecast data regarding condiment sales. However, the first frame 215 may display any type of content, such as, for example, any content related to business intelligence and/or problem solving utilities directed to business intelligence methodologies. In the illustrated example of FIG. 2, the user also views a second window or frame 220 containing data indicative of, for example, actual sales in various US markets. However, while the data related to the market forecast (e.g., shown in the first frame 215) may be local data developed and/or otherwise generated by, for example, the user's marketing team, the data relating to the actual US market sales (e.g., the data shown in the second frame 220) may originate from an independent third party external/normative application 120. While the example portal 105 of FIG. 2 illustrates two separate manners of reviewing report information (i.e., the first window 215 and second window 220), such windows are shown for illustrative purposes rather than as a limitation. Other display configurations (e.g., a different number of windows) may be chosen.

In the illustrated example of FIG. 2, the second frame 220 is an iFrame, which acts as a placeholder on the portal 105 for information obtained from the example external application 120. The example iFrame 220 allows presentation of data obtained from the external application 120 without burdening the portal 105 with significant formatting requirements. Similarly, the external application 120 may present data to the example iFrame 220 without processing significant formatting adjustments that may be unique and/or specific to a computer platform on which the portal 105 executes (e.g., UNIX, PC, etc.). The example iFrame 220 effectively allows the user of the portal 105 to “play within” the external application 120. FIG. 2 also illustrates in greater detail an example reach through manager 110 (with a dotted line).

In operation, the portal 105 builds context information for a desired report. Context information includes, without limitation, data that enables message handling. For instance, the report context information of the illustrated example includes selection criteria identifying a specific market, volume basis, a timeframe, a retailer, report formatting information, and/or one or more product lines. The portal 105 sends the context information to a context web server 225 within the reach through manager 110. The context web server 225 generates context extensible markup language (XML) to, in part, facilitate a representation of the context information in a manner that is common to dissimilar platform(s). In particular, the context web server 225 creates an instance of the context XML as a context identifier (hereinafter “contextID”). Rather than require the portal 105 and/or the external application 120 to receive all of the context information, the contextID may be used by the external application 120 as a reference when processing requests, thereby reducing and/or minimizing data transfer bandwidth requirements between the portal 105 and the external application 120, as discussed in further detail below. Generally speaking, the contextID “wraps” the context information and/or values associated therewith.

The context web server 225 of the illustrated example accesses an example data source 230 when generating the context XML. The data source 230 may include, but is not limited to, mapping tables to accommodate one or more specific mapping requirements of the external application 120 that may be included with the context XML and/or one or more uniform resource locators (URLs) that identify external application(s) location(s) on one or more network(s). Without limitation, the data source 230 may be implemented as a database, a memory, a Flash-RAM, a CD-ROM, a DVD-ROM, and/or a hard-disk drive. The context web server 225 stores the context XML to the example data source 230 for later use, as described in further detail below. On the other hand, the example context web server 225 also sends the contextID and/or URL to the portal 105, which builds the example iFrame 220 and reformats the URL to include and/or otherwise embed or reference the contextID therein. The iFrame 220 calls the external application 120 with the URL.

To further prevent the external application 120 from being inundated by numerous details and/or parameters of the context information, the contextID is extracted from the URL by the application interface 115. As discussed above, to minimize programming efforts and facilitate interoperability between the portal 105 and the external application 120, the application interface 115 is implemented as a web service hosted as an extension to the example external application 120. The example application interface 115 may be developed in any programming language without limitation, such as, for example, Java and/or Javascript.

Rather than lengthy XML data embedded in the initial request to the external application 120, the portal 105 sends the relatively small contextID. In the illustrated example, the application interface 115 receives the contextID, and passes the contextID back to the context web server 225 as a processing request. The example context web server 225 refers to the contextID to determine which context XML (previously generated based on the context information and stored in the data source 230) to send to the external application 120, and subsequently sends the determined context XML, thereby informing the external application 120 of, for example, query instructions requested by the user.

The external application 120 uses the determined context XML to identify express and/or default selections, thereby constraining/specifying how the external application 120 will employ its business logic to process the user requests. Additionally, or alternatively, the application interface 115 may receive the context XML and perform translation services to accommodate to specific operating commands and/or formats understood by the external application 120. To that end, the application interface 115 may translate specific commands of the context XML by referring to one or more libraries 231 stored in the data source 230. As additional external applications become available to a portal, specific operating and/or interface instructions/commands may be added to the libraries 231 of the data source, thereby allowing the application interface 115 to translate such context XML to one or more command(s). Without limitation, translation of the context XML to one or more command(s) may be performed by the context web server 225. In either example case, because the noted information is exchanged using a platform independent language, the external application 120 is permitted to operate with disparate platform types without significant customization. In the illustrated example, the external application 120 renders a report and returns such report data back to the requesting portal iFrame 220. The iFrame 220 displays the report in an appearance/format inherent to the external application 120. In other words, a user of the portal 105 views the report as if that user were directly accessing the selected external application 120. In this manner, the external application 120 need not be concerned with unique or custom formatting, as the iFrame 220 permits unaltered presentation of data from the external application.

FIG. 3 is a schematic illustration of yet another example manner of implementing the example system 100 of FIG. 1. The example system 300 facilitates, in part, additional formatting options for a user of the portal 105. As with the example system of FIGS. 1 and 2, the example system 300 of FIG. 3 illustrates only a single example portal 105 and a single example external application 120 for ease of illustration, but multiple portals 105 and/or multiple applications 120 may operate in the example SOA of FIG. 3 without limitation. In the illustrated example system 300, the portal 105 is similar to the portal 105 shown in FIGS. 1 and 2. In other words, the example portal 105 may operate under the control of a user to, for example, consolidate report results from disparate applications within and/or external to, a corporate entity associated with the portal 105.

The example portal 105 of FIG. 3 may include multiple segments and/or frames, in which report data may be presented to the user. In the illustrated example, the reach through manager 110 is shown with a dotted line. Requests for reports from the example portal 105 are received by an example rendering engine 315 within the reach through manager 110, but such requests may, instead, be forwarded directly to a handler manager 325, described in further detail below. The example rendering engine 315 receives context information from the portal 105 and processes requests that relate to one or more parameters such as, for example, key performance indicators (KPIs) of a business. KPIs are defined (e.g., by a manager or other business executive) for an organization (e.g., business, company, etc.) based on business goals, and identify how to measure whether such goals are being met. The defined KPIs may, for example, reflect critical success factors. Businesses may utilize various business intelligence (BI) systems to verify whether established goals reflected in the KPIs are consistent with actual external conditions, such as, for example, sales of a particular product in a specific geographic region and/or if the established goals are reached and/or appear to be reachable based on, in part, a project performance and/or future performance projections.

When the example rendering engine 315 of FIG. 3 receives context information from the portal 105, it calls the handler manager 325. However, in the event the example portal 105 is communicatively connected directly to the handler manager 325 (e.g., via communication line 326), such context information may be received directly from the portal 105. The example handler manager 325 of FIG. 3 references and/or retrieves one or more specific handlers 327 stored in and/or associated with a data source 230 based on the received context information. A handler is a defined template that may, among other things, specify report language, formatting, and/or logic. The example template may include, but is not limited to, particular verbiage that supports runtime string substitution based on data received from a data source (e.g., an external application). Results from the data source may be filtered with and/or processed by the handler to drive data analysis and/or prompt alternative queries during subsequent data acquisition attempts to the same and/or alternate data sources (e.g., other external applications). The handler logic may employ conditional logic that is tuned-to and/or specific to a particular industry of interest to the user. For example, the handler(s) may be aware of particular external applications that are likely to contain data and/or business logic that is particularly suited to solve a particular business problem and/or identify KPI status measurements.

Each example handler 327 may be associated with a globally unique identifier (GUID). Thus, the request transmitted from the portal 105 may propagate to the rendering engine 315 and handler manager 325 in the form of a GUID, which when referenced against the data source 230, identifies corresponding context information. In other words, the GUID invoked by the example portal 105 of FIG. 3 operates as a shortcut lookup, which minimizes the amount of data that the portal 105 is required to transmit to initiate a desired business intelligence operation from the external application 120.

In the illustrated example, handlers 327 stored in and/or associated with the data source 230 include logic and/or rules to perform various functions such as (by way of example, not limitation) mine for data, find root causes of performance trends, expose underperforming business drivers, and/or format received data in a desired manner. Additionally, the example libraries 231 include, among other things, commands formatted in a manner that may be understood by the external application of interest. Generally speaking, the handlers 327 employ one or more templates reflecting business specific verbiage, colorization, formatting, and/or business logic to, in part, drill-down data sources (e.g., external applications) and track KPIs. In particular, because the example handlers 327 may operate as templates, context information from the portal 105 may not be necessary to further define parameters associated with the desired business intelligence operation. However, in the event such context information is provided by the portal 105, it may further define additional and/or alternate report parameters.

Additionally, the example business handler(s) 327 may identify particular data sources that are internal and/or external to the user's immediate business. As discussed above, such data sources and/or processing services may be accessible to the user by virtue of a contractual relationship that allows the user's organization authorized access to one or more applications and/or services, and/or such sources may be publicly available.

In the example of FIG. 3, the example handler(s) 327 retrieved from the data source 230 are forwarded to an application interface 115. The example handler(s) 327 that are passed to the example application interface 115 of FIG. 3 include context information (e.g., the context information associated with the handler template itself, plus any additional and/or alternate context information provided by the example portal 105) upon which the external application 120 operates. However, for purposes of bandwidth conservation, the handler information passed to the application interface 115 may omit specific colorization and/or formatting information that will, instead, be used by the example rendering engine 315 and/or handler manager 325 to format data for display at the portal 105, as discussed in further detail below. In the example of FIG. 3, the external application 120 employs business logic responsive to, or constrained by, the context information associated with the example handler 327 to perform one or more functions, such as analyzing, formatting, and/or retrieving data. When the external application 120 completes the function(s), the format of the result may not be in a condition viewable by the portal 105, or may not be in a format understood by the handler manager 325. As a result, the application interface 115 places the results into a platform independent format, such as an XML format (e.g., an XML file) that can be read by the handler manager 325. As a result of this translation to a platform independent format, the application interface 115 reduces and/or eliminates custom modification tasks by the external application 120, and may operate as a web service that is not intimately tied-in to the logic of the external application 120.

In the illustrated example, the example application interface 115 forwards the XML file to the example handler manager 325 where it is further modified in view of colorization and/or other formatting specified by the handler 327 parameters. Because handlers 327 may be tailored to any specific industry, a handler designer (e.g., the user, a manager, a business analyst, etc.) may incorporate various parameters, formatting, and/or business logic to enhance and/or resolve business objectives. Accordingly, the handler manager 325 of the illustrated example translates the received XML file into a format understood by the rendering engine 315. The example rendering engine 315 builds the report based on the data returned by the external application 120 using the formatting and/or colorization data specified by the handler 327, and sends the rendered report to the portal 105 for presentation to the user.

While FIG. 2 and FIG. 3 illustrate example reach through managers 110, the systems described in FIGS. 1-3 (100, 200, 300) may be implemented and/or combined in many alternative manners.

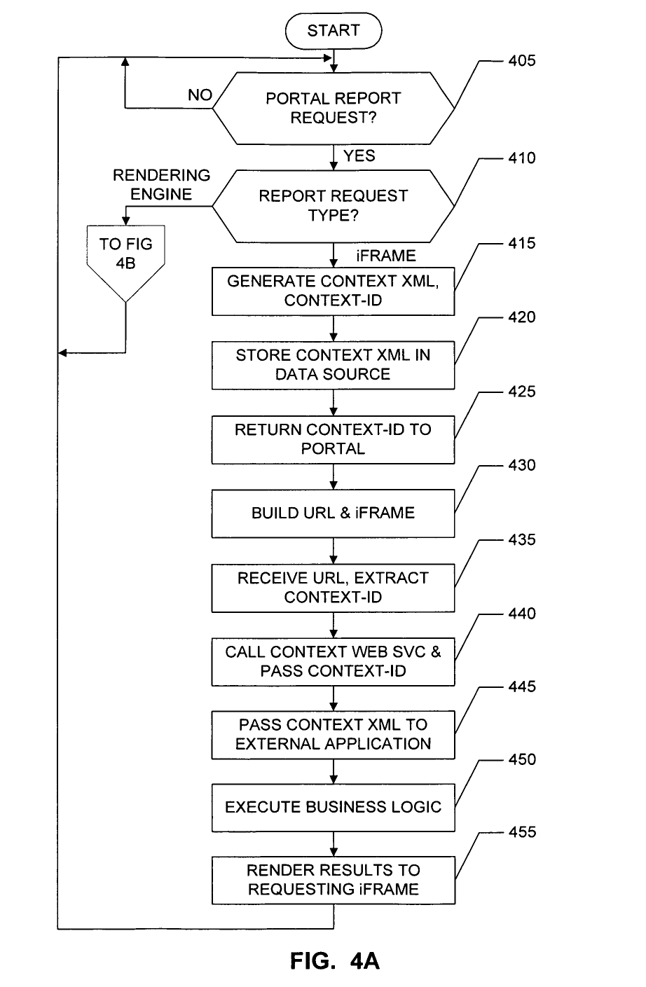

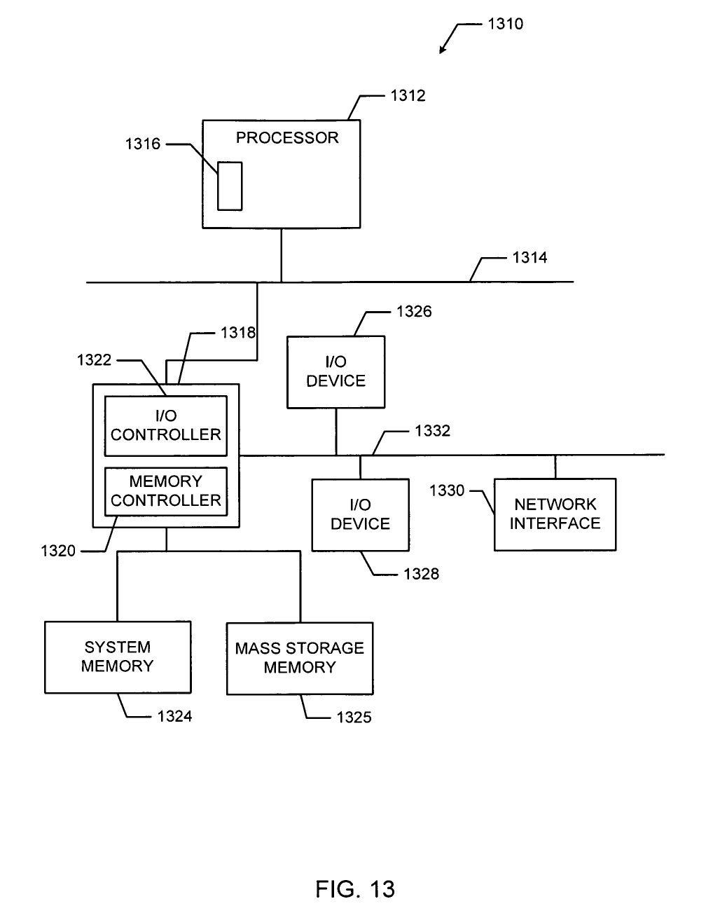

Flowcharts representative of example machine readable instructions for implementing the systems 100, 200, and/or 300 of FIGS. 1-3 are shown in FIGS. 4A and 4B. In this example, the machine readable instructions comprise one or more programs for execution by one or more processors such as the processor 1312 shown in the example processor system 1310 discussed below in connection with FIG. 13. The program(s) may be embodied in software stored on a tangible medium such as a CD-ROM, a floppy disk, a hard drive, a digital versatile disk (DVD), or a memory associated with the processor 1312, but the entire program and/or parts thereof could alternatively be executed by a device other than the processor 1312 and/or embodied in firmware or dedicated hardware in. For example, any or all of the portal 105, the first frame 215, the second frame 220 (iFrame), the reach through manager 110, the context web server 225, the application interface 115, the rendering engine 315, and/or the handler manager 325 could be implemented (in whole or in part) by software, hardware, and/or firmware. Further, although the example program is described with reference to the flowchart illustrated in FIGS. 4A and 4B, many other methods of implementing the example systems 100, 200, 300 may alternatively be used. For example, the order of execution of the blocks may be changed, and/or some of the blocks described may be changed, eliminated, or combined.

An example program for reaching through to external applications 120 is shown in FIGS. 4A-4B. This program may be scheduled and/or periodically executed to access one or more internal and/or external applications.

The program of FIGS. 4A and 4B begin at block 405 where the example system (100, 200, 300) waits for a user to request a report. If no report is requested, then the program waits in a loop until user-action is received at the example portal 105. However, a report request initiated by the user at the portal 105 (block 405) is analyzed to determine if such report request corresponds to the user navigating to an example iFrame 220 or whether the user requests a report based on KPIs that are serviced by an example rendering engine (block 410), such as the example rendering engine 315 of FIG. 3. If the report request is determined to involve the example rendering engine 315 (block 410), the example program advances to block 465 of FIG. 4B, discussed in further detail below. On the other hand, if the report request is determined to include iFrame navigation by the user (block 410), then the example portal 105 generates context information based on, for example, report parameters selected by that user. Such report parameters may be presented to the user in the portal 105 in any number of ways, such as, for example, via a drop down list, graphical buttons, text entry fields, and/or checkboxes. Additionally, the report parameters may include selections based upon the user's interests, business objectives, KPIs, and/or parameters that reflect known capabilities of internal and/or external business intelligence applications. As described above, example report context information may include, but is not limited to, specific market(s), volume revenue, margin, timeframe(s), and/or particular product lines.

The context information provided by the example portal 105 may be, alternatively, in the form of a GUID that is associated with a unique set of context information stored in the data source 230. For example, because context information may include a significant number of individual parameters, a GUID associated with a particular combination of such parameters may be sent by the portal instead of a plurality of parameters. Regardless of whether context information is passed as multiple parameters (e.g., Supermarkets grossing greater than $2Mil, Pacific Northwest region, Condiment sales, Sales constrained between 2004-2005, etc.), or as a GUID referring to a particular set of parameters, such context information and/or GUID is received by the example context web server 225 (block 415).

The example context web server 225 of FIG. 2 generates an XML file of the context information received by the portal 105 (block 415) and stores the resulting XML context information in the example data source 230 (block 420). Additionally, as discussed above, the example context web server 225 creates an example contextID (block 415), which is an instance of the context XML to be used as a reference for the external application 120. Similar to the XML context file, the example contextID is stored in the data source 230 (block 420). However, if the example context web server 225 is provided with the GUID instead, or in addition to context information, the context web server 225 queries the data source 230 for a matching GUID reference. In the illustrated example, each of the GUID references stored in the data source 230 is associated with a respective one of a plurality of stored combinations of context information, thereby reducing data bandwidth requirements of the example portal to transfer the context information. The stored combination of context information corresponds to a particular set of context information, which may be frequently requested by users. As a result, the example portal 105 need only send the GUID value, and the context web server initiates the task of querying the data source 230 by using the GUID value to retrieve the corresponding combination of context information and then generating the context XML file and contextID built on that returned information (block 415).

The example context web server 225 returns the contextID to the portal 105 (block 425). The portal 105 builds the example iFrame 220 based on, in part, the specific context information associated with the report of interest, and assembles a URL embedded with the contextID that was provided by the context web server 225 (block 430). The example iFrame 220 calls the application interface 115 associated with the external application 120 using the URL. The application interface 115 at the external application 120 receives the URL and extracts the contextID embedded within the transmitted URL (block 435).

In the illustrated example, the application interface 115 is aware of, and communicatively connected to, the context web server 225 of FIG. 2 and calls the context web server 225 using the received contextID (block 440) when the external application 120 is available to respond to the request. For example, the external application 120 may be consumed by any number of requesters, thereby requiring that the external application 120 manage its processing time accordingly. The external application 120 may respond to requests on a first-come-first-served basis, by, for example, placing all requests in a sequential queue. Additionally, or alternatively, the external application 120 may require authentication before processing a request. For example, the external application 120 may validate authentication credentials submitted with the transmitted URL to confirm that the requester has a payment account in good standing.

Upon receipt of the contextID from the application interface 115, the context web server 225 of FIG. 2 passes the previously generated XML file to the external application 120 (block 445). The external application 120 executes its business logic based on the parameters/constraints of the XML file (block 450), which is indicative of the context information originally requested by the user of the portal 105. When the example external application 120 is finished processing the request, the results are rendered back to the requesting iFrame 220 (block 455), thereby allowing the user to review the results at the portal 105. Control then returns to block 405 to await subsequent report requests.

Returning to block 410 of FIG. 4A, if the report request references services from the example rendering engine 315 of FIG. 3 (block 410), then the example program of FIG. 4A advances to block 465 of FIG. 4B. In the illustrated example, the report request is received by the rendering engine 315 of the reach through manager 110, as illustrated in FIG. 3 and discussed above. While FIGS. 2 and 3 were illustrated separately for clarification purposes, the elements of FIGS. 2 and 3 may be combined into a single consolidated system, without limitation. Such report requests may include context information and/or a GUID, as described above. The context information may include KPIs that the example rendering engine 315 is capable of processing based on one or more example handlers 327, which may include logic and/or rules to perform various functions (e.g., to mine for data in particular external applications, to determine root causes of performance trends, to expose underperforming business drivers, and/or to format received data in a predetermined manner (e.g., colorization, placement, fonts, etc.)).

An indication of context information, whether such indication is the context information itself, and/or the GUID that is passed to the example rendering engine 315, is forwarded to the example handler manager 325. The handler manager 325 uses the received information to locate a specific handler 327 to process the portal 105 request (block 465). If the example handler manager 325 receives a GUID, then the GUID is referenced against (i.e., used as an index to locate) a match in the data source 230 for a corresponding GUID and associated context information (block 465). The example handler 327 retrieved from the data source 230 is then passed to the application interface 115 associated with the target external application 120 (block 470).

Using the context information contained within the example handler 327 the application interface 115 identifies and forwards commands to the external application 120 for execution (block 475). As described above, the functions executed by the example external application(s) 120 requested by the user may serve a valuable purpose for the user's business based on, in part, the content of its database and/or the particular business logic applied to the external application's database. To determine one or more appropriate commands to be executed by the external application 120, the application interface 115 references one or more libraries 231 associated with the external application of interest. Results generated by the example external application 120 are received and formatted by the application interface 115 into an XML format (e.g., an XML file) (block 480).

The XML file is forwarded by the application interface 115 to the example handler manager 325, which adds formatting requirements and/or preferences to the received data (block 485). For example, in the interest of network bandwidth conservation, the context information provided to the external application 120 may be devoid of formatting parameters (e.g., colorization, fonts, field placement, etc.). As such, the external application 120 may be utilized for only its streamlined expertise and not burdened with disparate formatting tasks due to non-homogeneous requestor platforms (e.g., UNIX platforms, PC platforms, etc.). In the illustrated example, the handler manager 325 passes the XML file and the formatting parameters to the rendering engine 315 (block 490), which renders one or more particular graphical, textual, and/or color schemes for the report to be displayed to the user at the portal 105 (block 495).

The example systems, methods, apparatus, and/or articles of manufacture discussed above may be further modified to enable an application to retrieve information from two or more (i.e., a plurality) of separate data sources without requiring a user to repeatedly provide selection criteria indicative of the information to be retrieved. In particular, the example systems, methods, and apparatus described herein provide an application the ability to receive user-provided selection criteria from a user, to store (e.g., persist, save, etc.) the user-provided selection criteria, and to subsequently use the user-provided selection criteria a plurality of times to retrieve information from a plurality of separate (e.g., different) data sources in response to, for example, the user requesting to view the information.

As discussed above, the example systems, methods, and apparatus described herein may be used to implement a user-accessible network-based or web-based portal (e.g., an information retrieval application) configured to access and retrieve information from a plurality of data sources and display the information to a user. As used herein, data sources include, for example, databases, servers, data structures, storage areas, or any other device, system, or process that can store and/or communicate requested information to an information retrieval application. In an example implementation used to conduct business research or market research, the user-accessible web-based portal (i.e., the portal) can be configured to display the retrieved information in, for example, report formats or any other format (e.g., charts, paragraphs, tables, etc.) to enable a user to view the requested information. For example, a user could specify selection criteria indicative of a particular market (e.g., a geographic area, an age group, etc.) to view a particular user-specified or default report (e.g., revenues report, quantities sold report, etc.) based on the selection criteria. The portal can then retrieve the information corresponding to the user-specified selection criteria and store the user-specified selection criteria for subsequent use. That is, when the user requests to view other types of reports based on the same selection criteria, the user need not re-enter the selection criteria. Instead, the portal can use the stored user-provided selection criteria to retrieve information for any report subsequently requested by the user. To view a different report, the user merely specifies the report of interest, and the portal then automatically uses the stored user-provided selection criteria to retrieve the information for the requested report from a data source, such as from the example data source(s) and/or external application(s) 120 described above in view of FIGS. 1-3.

In some example implementations, some data sources and/or applications are native data sources and other data sources are normative data sources (e.g., external data sources, external applications, etc.). As described above, the example external application(s) 120 may include one or more databases and/or services. Normative data sources and/or normative applications are also referred to herein as external data sources and external applications, respectively. As used herein, a native data source is configured to store and communicate information using a substantially similar or identical format or data arrangement as other native data sources and/or a data retrieval application (e.g., a portal). In addition, each of the native data sources may be configured to use the same or substantially the same data access interface protocol or data access interface format to enable an information retrieval application (e.g., a portal) to request information and receive information from any native data source using the same data format and/or data access interface protocol. The example systems, methods, and/or apparatus described herein can be used to retrieve information based on user-provided selection criteria from native and/or normative (i.e., external) data sources.

An example method of retrieving information involves receiving a selection criterion (e.g., a native selection criterion) associated with information stored in a native data source, storing the native selection criterion in a first data structure, and associating an identifier (ID) with the first data structure. To retrieve information from a normative (i.e., external) data source based on the native selection criterion, a mapped data structure is generated based on the ID by mapping the native selection criterion to a normative selection criterion associated with the information stored in the normative data source. The information is then retrieved from the normative (i.e., external) data source based on the normative selection criterion in the mapped data structure.

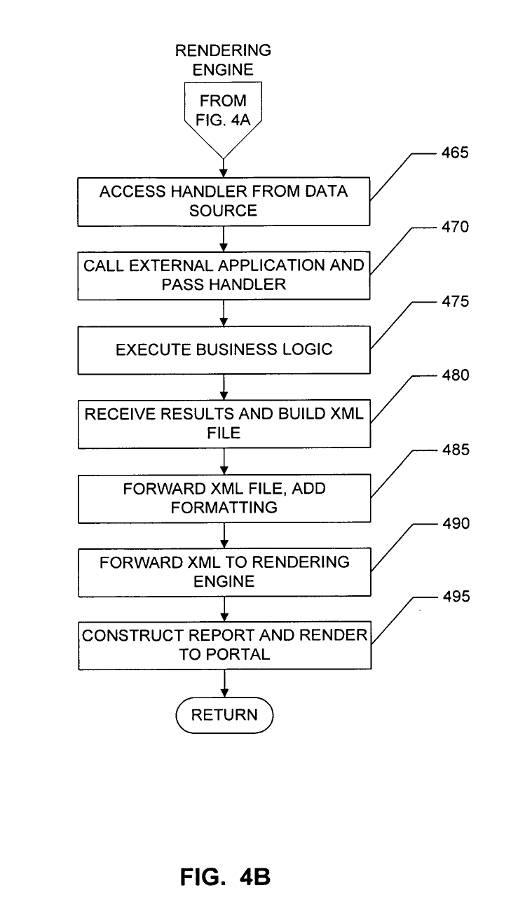

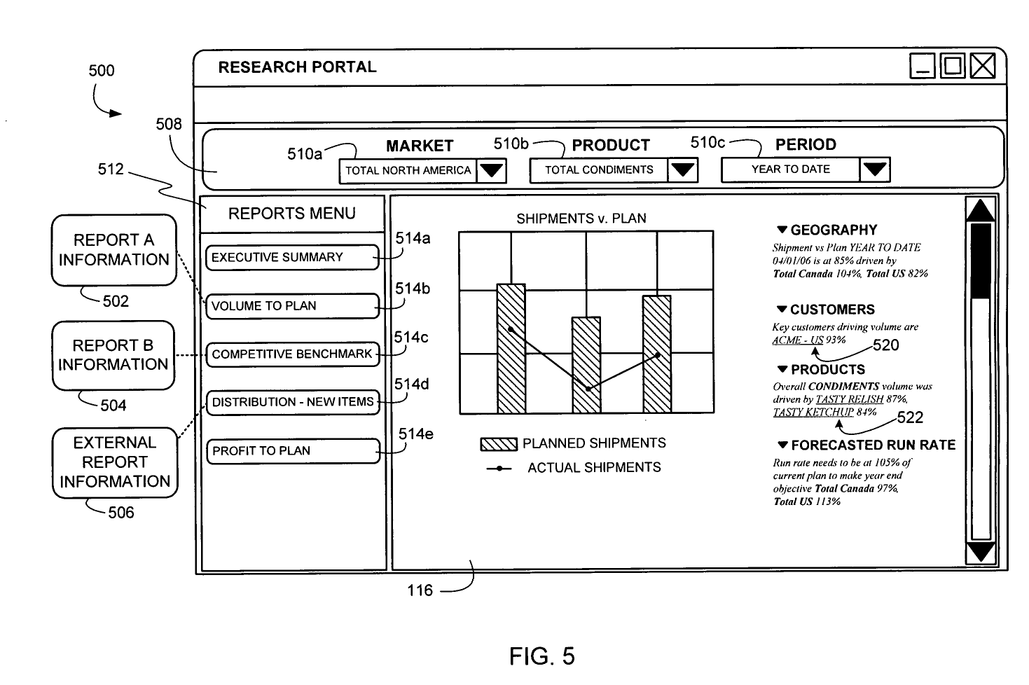

FIG. 5 depicts an example graphical user interface (GUI) 500 of an information retrieval application (e.g., the portal 602 of FIG. 6) used to retrieve report information 502, 504, and/or 506 from a plurality of separate data sources (e.g., data sources 612 and 620 of FIG. 6) without requiring a user to repeatedly provide selection criteria indicative of the information to be retrieved. To enable a user to specify selection criteria indicative of the information that the user would like to view, the GUI 500 is provided with a criteria selection toolbar 508 having a plurality of criterion selection fields 510a-c. The criterion selection fields 510a-c provide a plurality of criteria from which a user may select. As described in greater detail below, available selection criteria are provided to the criterion selection fields 510a-c using tables of contents (TOC) provided by data sources. Each data source is associated with a respective TOC that indicates the type of information that may be retrieved from that data source. For example, a data source having information associated with fast food restaurant sales may provide a TOC having selection criteria associated with, for example, regions of fast food sales, types of fast food sold, etc. In some example implementations, a data source may be associated with a plurality of TOC, each of which corresponds to a different user or user account having access (e.g., login access, data access, etc.) to the data source. The selection criteria included in each TOC may vary based on respective user accounts. For example, a user account may indicate permissible access to information associated with only a subset of selection criteria (e.g., condiment sales volume and revenue) associated with a respective data source (e.g., a data source that stores sales volumes and revenues for many different types of foods). Thus, for a particular data source, a user account may be uniquely associated with a TOC having a subset of selection criteria different from another TOC.

In the illustrated example, the criterion selection fields 510a-c are implemented using drop-down lists. In the illustrated example, a drop-down list displays selection criteria available to a user when the user clicks on the drop-down list. However, in other example implementations, the selection criterion fields 510a-c may be implemented using any other GUI control. In addition, although three criterion selection fields 510a-c are shown, the criteria selection toolbar 508 may be provided with any number of criterion selection fields 510a-c. For example, the criteria selection toolbar 508 may have one or more criterion selection fields.

To enable a user to select a type of report to view based on the user-specified criteria selected via the criteria selection toolbar 508, the GUI 500 is provided with a reports menu 512. The reports menu 512 includes a plurality of report selectors 514a-e. Each of the report selectors 514a-e corresponds to a particular data source. In the illustrated example, the ‘Volume to Plan’ report selector 514b corresponds to a native data source configured to provide the report A information 502, the ‘Competitive Benchmark’ report selector 514c corresponds to a native data source configured to provide the report B information 504, and the ‘Distribution—New Items’ report selector 514d corresponds to a normative (i.e., external) data source configured to provide the normative report information 506.

In an example implementation, after a report is selected (e.g., a user selects one of the report selectors 514a-e or a default report is enabled upon initial login based on user account default settings) the data source configured to provide the selected report can provide its TOC to populate the available selection criteria in the criterion selection fields 510a-c. A user can then specify one or more criterion via the criteria selection toolbar 508 and one of the report selectors 514a-e to retrieve information based on the user-provided criteria from a data source corresponding to the selected one of the report selectors 514a-e. In some example implementations, native data sources may be configured to have the same criteria (e.g., native criteria) in their TOC. That is, the selection criteria from which a user can select to retrieve information from a native data source may be the same for all of the native data sources. For example, if the criterion selection fields 510a-c include native selection criteria common to native data sources associated with the report selectors 514b-c and a user specifies ‘Total North America’, ‘Total Condiments’, and ‘Year to Date’ in the criteria selection toolbar 508, an information retrieval application (e.g., the portal 602 of FIG. 6) can use the specified native selection criteria to retrieve report information from either of the native data sources without requiring to map the selection criteria associated with one native data source to selection criteria associated with another native data source.

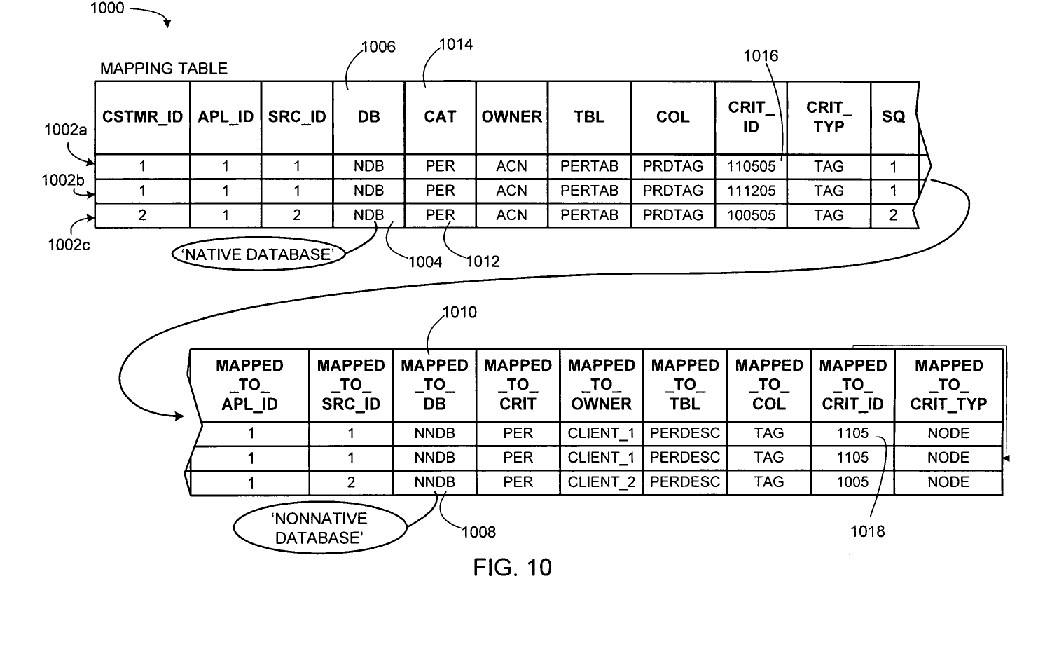

In some example implementations, the TOC for normative (i.e., external) data sources may contain selection criteria (e.g., external selection criteria) different from the selection criteria associated with the native data sources. Thus, in the illustrated example, when the user selects the ‘Distribution—New Items’ report selector 514d while viewing the report A information 502, the user-specified criteria (e.g., the criteria available for the report A information 502) specified via the criteria selection toolbar 508 are stored and assigned an identifier (ID). The ID can then be used to map the specified native selection criteria to corresponding selection criteria (e.g., normative selection criteria) associated with the normative data source configured to provide the normative report information 506 using mapping tables (e.g., the mapping table 624 of FIGS. 6 and 1000 of FIG. 10) as described below. If the user elects to change the selection criteria while viewing the normative (i.e., external) report information 502, the selection criteria available via the criterion selection fields 510a-c will be indicative of the normative criteria associated with the normative data source that provided the normative report information 506. In addition to mapping native selection criteria to normative (i.e., external) selection criteria, the example systems, methods, and apparatus described herein can also be used to map normative selection criteria to native selection criteria when a user navigates from normative report information (e.g., the external/normative report information 506) to native report information (e.g., the report A information 502 or the report B information 504).

To display report information, the GUI 500 is provided with a report display area 516. In the illustrated example, the report display area 516 is configured to display report information in chart format, graph format, pictorial format, and/or textual format. Also in the illustrated example, textual representations of report information may be configured to include user-selectable selection criteria 520 and 522. The selectable selection criteria 520 and 522 correspond to selection criteria that may also be available for selection via the criterion selection fields 510a-c. Thus, the selectable selection criteria 520 and 522 are provided by a data source via the TOC of that data source. When a user selects one of the selectable selection criteria 520 and 522, a corresponding one of the criterion selection fields 510a-c displays the text (e.g., ‘ACME-US’) corresponding to the selected one of the selectable selection criteria 520 and 522.

FIG. 6 is a block diagram of an example system 600 configured to retrieve information from a plurality of data sources to enable retrieving information from the plurality of data sources. To host the GUI 500 of FIG. 5 and retrieve information (e.g., the report information 502, 504, and 506 of FIG. 5) from native and/or normative (i.e., external) data sources, the example system 600 is provided with a portal 602. Each time a user specifies different selection criteria via the criteria selection toolbar 508 (FIG. 5), the example portal 602 of FIG. 6 creates or instantiates a criteria context data structure 604 to store the selection criteria for use in retrieving any subsequent report information while the selection criteria remains unchanged. In the illustrated example, to generate context data structure(s), the portal 602 is provided with a context manager 606. The context manager 606 creates a context data structure (e.g., the context data structure 604) by pairing or associating a criterion type and a criterion identifier (ID) corresponding to each of the specified selection criterion to form one or more criterion type/ID pairs. For example, if the user specifies the criterion ‘North America’ via the ‘Market’ criterion selection field 510a of FIG. 5, the context manager 606 creates a criterion type/ID pair for the selection that specifies ‘Market/North America’, in which ‘Market’ corresponds to the criterion type and ‘North America’ corresponds to the criterion ID. When the user specifies different selection criteria, the context manager 606 creates a different context data structure defined by the updated selection criteria. In the illustrated example, the context manager 606 is configured to create the criterion type/ID pairs using an XML format. That is, the context manager 606 creates an XML entry for each criterion type/ID pair corresponding to each specified selection criterion. However, any other format may alternatively be used to implement the criterion type/ID pairs.

It is preferable, but not necessary, that the context manager 606 be configured to create criterion type/ID pairs when a user selects to navigate from a native report to a normative (i.e., external) report or to navigate from a normative (i.e., external) report to a native report. It is also preferable, but not necessary, that the context manager 606 be configured not to create criterion type/ID pairs when a user selects to navigate between different native reports associated with the same selection criteria. For example, the context manager 606 may be configured to create the criterion type/ID pairs when the GUI 500 is displaying the report A information 502 (FIG. 5) and the user selects the ‘Distribution—New Items’ report selector 514d to view the normative report information 506 (FIG. 5). By way of further example, the context manager 606 may be configured not to create criterion type/ID pairs when the GUI 500 is displaying the report A information 502 and the user selects the ‘Competitive Information’ report selector 514c (FIG. 5) to view the native report B information 504 (FIG. 5).

To store the context data structure 604, the example system 600 is provided with a context service interface 608. When the context manager 606 generates the context data structure 604, the context manager 606 communicates the context data structure 604 to the context service interface 608. When the context manager 606 generates the context data structure 604, the context manager 606 communicates the context data structure 604 to the context service interface 608. The context service interface 608 stores the context data structure 604 in, for example, a memory 610 and assigns the context data structure 604 a context ID. In this manner, the context manager 606 or any other entity in the example system 600 can reference the context data structure 604 using the context ID. In some example implementations, the context service interface 608 may be implemented using a web-based interface that enables the portal 602 to communicate with the context service interface 608 using a web communication protocol (e.g., hyper-text transfer protocol (HTTP)).

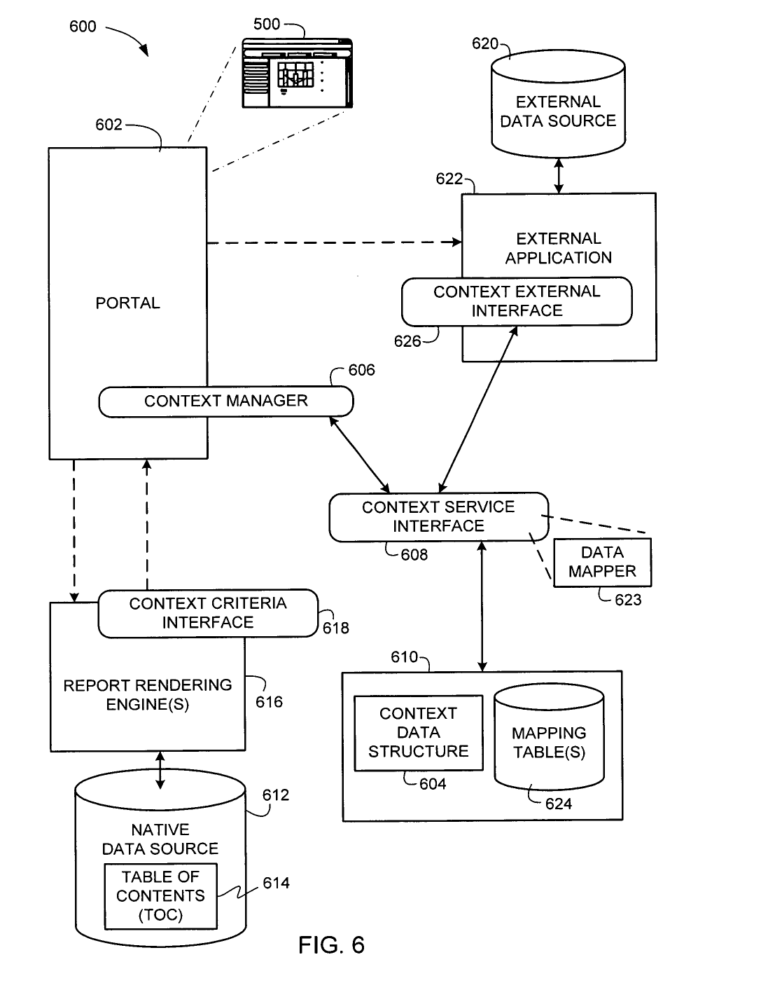

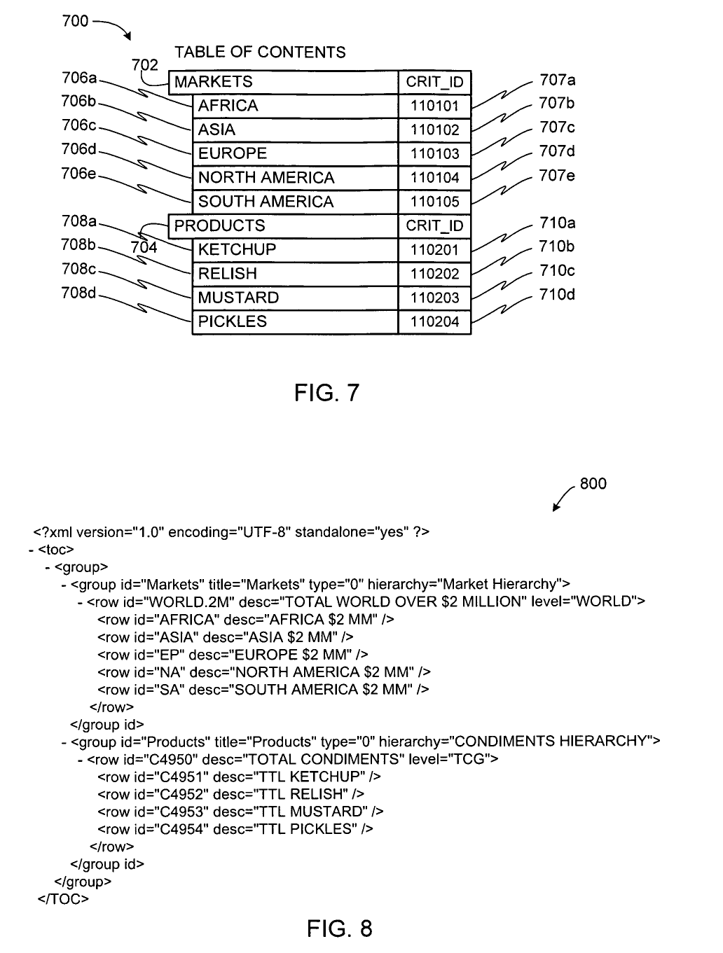

In the example of FIG. 6, a native data source 612 is provided to store and provide information (e.g., the report A information 502 and/or the report B information 504 of FIG. 5) requested by a user via the GUI 500. A table of contents (TOC) 614 defines the plurality of selectable selection criteria associated with the native data source 612. An example TOC representation and an example XML-coded TOC that may be used to implement the TOC 614 are shown in FIGS. 7 and 8, respectively. To render reports corresponding to information retrieved from the native data source 612, the example system 600 of FIG. 6 is provided with a report rendering engine 616. For example, the report rendering engine 616 may be configured to render reports using one or more of chart formats, graph formats, pictorial formats, textual formats, etc. and may be used to render, for example, reports such as those shown in the GUI 500 of FIG. 5. In the illustrated example, the report rendering engine 616 is a native application relative to the portal 602. The report rendering engine 616 is configured to communicate rendered reports to the portal 602 to enable the portal 602 to display the rendered reports via the GUI 500. In some example implementations, the report rendering engine 616 may be implemented using web-based technologies to enable the report rendering engine 616 to render reports displayable via a web page. Although for ease of illustration only one report rendering engine (e.g., the report rendering engine 616) is shown, any number of report rendering engines may be provided.

In the illustrated example, to communicate the TOC 614 having the selection criteria selectable for retrieving information from the native data source 612, the example system 600 is provided with a context criteria interface 618. For example, if the report A information 502 of FIG. 5 is stored in the native data source 612 and a user selects the ‘Volume to Plan’ report selector 514b of FIG. 5 (which corresponds to displaying the report A information 502), the context criteria interface 618 communicates the TOC 614 to the portal 602. In this manner, the portal 602 can populate selectable selection criteria in the criterion selection fields 510a-c of FIG. 5 to enable a user to specify selection criteria associated with the native data source 612.

In the illustrated example, a normative (i.e., external) data source 620 is provided to store and provide normative report information (e.g., the external report information 506 of FIG. 5) requested by a user via the GUI 500. A normative application 622 is provided to exchange normative report information between the portal 602 and the normative data source 620. The normative (i.e., external) application 622 may be, for example, a SAP application that is configured to communicate with the normative data source 620 and receive information requests from other application(s) (e.g., the portal 602) to provide information from the normative data source 620 to those applications. In the illustrated example, although the normative data source 620 may be configured to provide a listing of its selectable selection criteria, the normative data source 620 may not necessarily provide the selection criteria listing via a TOC. However, in other example implementations, the normative data source 620 may have a TOC containing its selectable selection criteria defined using, for example, normative values (e.g., external descriptions, external keys, external ID's, etc.).

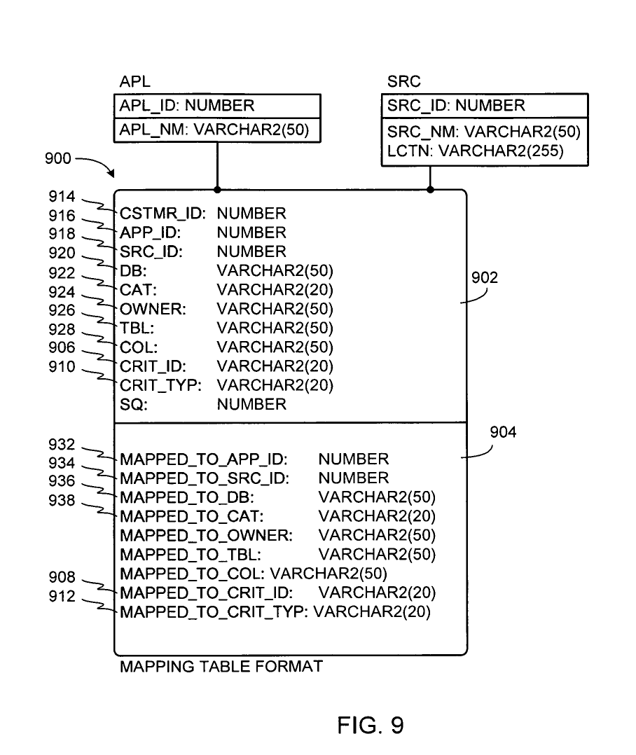

In the example of FIG. 6, the context service interface 608 is provided with a data mapper 623 configured to generate a mapping table 624, which provides a mapping of selection criteria associated with different data sources. In the illustrated example, the mapping table 624 maps native selection criteria corresponding to the native data source 612 to normative selection criteria corresponding to the normative data source 620. In an example implementation, the TOC 614 of the native data source 612 may include a native ‘North America Sales’ criterion corresponding to sales of every country in North America while the normative data source 620 may have a normative ‘United States’ criterion corresponding to sales information of only the United States. To enable a user to view normative report information (e.g., the external report information 506 of FIG. 5) stored in the normative data source 620 based on the selected ‘North America Sales’ criterion associated with the TOC 614, the mapping table 624 maps the normative ‘United States’ criterion associated with the normative data source 620 to the native ‘North America Sales’ criterion associated with the native data source 612. In this manner, when the user requests to view the normative report information 506 based on the specified native ‘North American Sales’ criterion, the normative application 622 can retrieve the requested information from the normative data source 620 based on the normative ‘United States’ criterion indicated via the criterion mapping in the mapping table 624. An example mapping table format that may be used to implement the mapping table 624 is shown in FIG. 9. An example mapping table is shown in FIG. 10. Although for ease of illustration, only one mapping table (e.g., the mapping table 624) is shown in FIG. 6, the example system 600 may be provided with any number of mapping tables.

To enable the normative (i.e., external) application 622 to retrieve requested information from the normative (i.e., external) data source 620 based on the selection criteria specified via the criteria selection toolbar 508 (FIG. 5), the example system 600 of FIG. 6 is provided with a context external interface 626. For example, to retrieve the normative information 506 (FIG. 5) from the normative data source 620, the example portal 602 of FIG. 6 forwards a request to the normative application 620 including the context ID associated with the context data structure 604. The context external interface 626 then communicates the context ID to the context service interface 608 with a request to receive the normative selection criteria associated with the normative data source 620 that corresponds to the user-specified native selection criteria stored in the context data structure 604. In the illustrated example, the normative selection criteria are mapped to the native selection criteria in the mapping table 624. In response to receiving the request from the context external interface 626, the context service interface 608 can retrieve the normative selection criteria from the mapping table 624 and communicate the normative selection criteria to the context external interface 626. In this manner, the normative application 622 can retrieve the normative report information 506 (FIG. 5) from the normative data source 620 corresponding to the native user-specified selection criteria specified via the GUI 500 and stored in the context data structure 604.

In the illustrated example, the context external interface 626 is also configured to communicate a normative (i.e., external) TOC associated with the normative (i.e., external) data source 620 to the portal 602 via the context service interface 608 to enable the portal 602 to populate the criteria selection toolbar 508 with available normative selection criteria associated with the normative data source 620. If the user subsequently selects to retrieve other normative information from the normative data source 618, the context external interface 626 can provide the requested information based on the normative selection criteria specified by the user via the criteria selection toolbar 508 without needing to map between native and normative selection criteria again. That is, the data mapper 623 may be configured to map between native and normative selection criteria only when a user elects to navigate from a native report to a normative report or from a normative report to a native report. However, the data mapper 623 may be configured not to map between native and normative (i.e., external) selection criteria when a user navigates to different normative reports that use normative information retrieved from the normative data source 620.

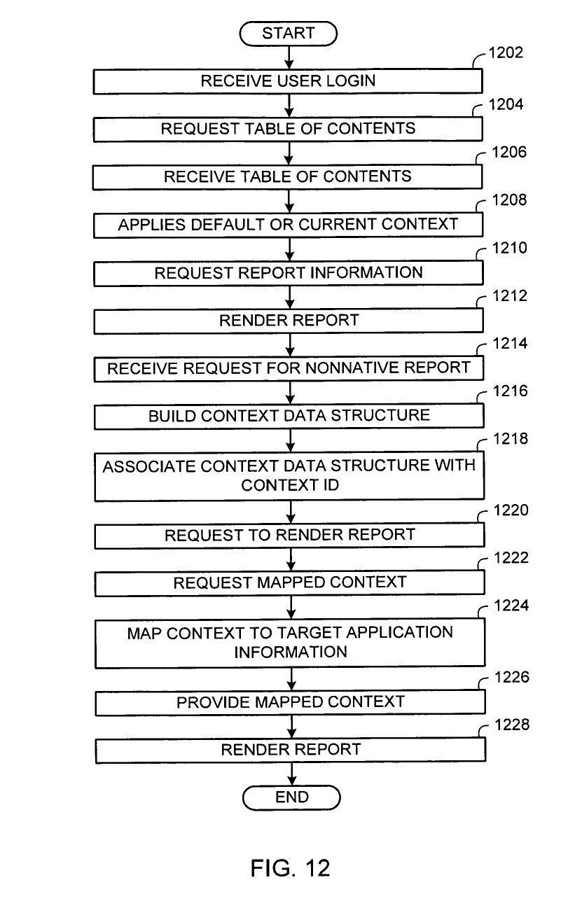

The context manager 606, the context service interface 608, the context criteria interface 618, the data mapper 623 and the context external interface 626 may be implemented using any desired combination of hardware, firmware, and/or software. For example, one or more integrated circuits, discrete semiconductor components, or passive electronic components may be used to implement these structures. Additionally or alternatively, some or all of the context manager 606, the context service interface 608, the context criteria interface 618, the context external interface 626, and/or parts thereof, may be implemented using instructions, code, and/or other software and/or firmware, etc. stored on a machine accessible medium that, when executed by, for example, a processor system (e.g., the example processor system 1310 of FIG. 13), perform the operations represented in the flowchart of FIG. 12. In the illustrated example, some or all of the context manager 606, the context service interface 608, the context criteria interface 618, and/or the context external interface 626 may be distributed among various network entities (e.g., various servers) in the example system 600. However, in alternative example implementations, some or all the context manager 606, the context service interface 608, the context criteria interface 618, and/or the context external interface 626 may be implemented using the same network entity (e.g., the same server).

FIG. 7 is an example table of contents 700 that may be used to implement the table of contents 614 of FIG. 6. In the illustrated example, the TOC 700 includes two types of criteria, namely, a markets criterion type 702 and a products criterion type 704. Under the markets criterion type 702, the TOC 700 includes a plurality of criteria 706a-e, each of which is associated with a unique criterion ID 707a-e. Under the products criterion type 704, the TOC 700 includes a plurality of criteria 708a-d, each of which is also associated with a unique criterion ID 710a-d. In the illustrated example, the portal 602 (FIG. 6) can use the criteria 706a-e and 708a-d to populate selectable criteria in the criterion selection fields 510a-c of FIG. 5. For example, the portal 602 may populate the ‘Market’ criterion selection field 510a with any or all of the criterion 706a-e and populate the ‘Product’ criterion selection field 510b with any or all of the criterion 708a-d. In this manner, when a user selects, for example, the ‘Market’ criterion selection field 510a, the criterion 706a-e are shown via a drop-down list. In an example implementation, the TOC 700 may be implemented using a TOC 800 implemented using XML as shown in FIG. 8.

FIG. 9 depicts an example mapping table format 900 that may be used to implement the mapping table 624 of FIG. 6. In the illustrated example, the example mapping table format 900 includes a native parameter portion 902 and a normative (i.e., external) mapped parameter portion 904. Although the parameter portions 902 and 904 are described as corresponding to native and normative parameters, in other example implementations, the mapping table format 900 may be used to map selection criteria associated with different native data sources. For example, the mapping table format 900 could be used to map selection criteria associated with a first native data source to different selection criteria associated with a second native data source. In yet other example implementations, the mapping table format 900 may be used to map selection criteria associated with different normative data sources. For example, the mapping table format 900 could be used to map selection criteria associated with a first normative data source to different selection criteria associated with a second normative data source.

In the illustrated example of FIG. 9, the native parameter portion 502 includes a criterion ID parameter 906 that is mapped to a mapped to criterion ID parameter 908 in the normative (i.e., external) parameter portion 904. In addition, the native parameter portion 902 includes a criterion type parameter 910 that is mapped to a mapped to criterion type parameter 912 in the normative mapped parameter portion 904. The criterion type parameter 910 may be used to indicate whether a criterion indicated by the criterion ID parameter 906 is, for example, a market criterion type (e.g., the markets criterion type 702 of FIG. 7) or a product criterion type (e.g., the products criterion type 704 of FIG. 7). Other criteria in the example mapping table format 900 of FIG. 9 include a customer ID 914 to indicate a customer (e.g., a user) of a portal service (e.g., a service provided by the portal 602 of FIG. 6), an application ID 916 to identify an application (e.g., a native application or the report rendering engine 616 of FIG. 6) corresponding to a particular mapping table entry, a source ID 918 to identify a data source (e.g., the native data source 612 of FIG. 6) corresponding to the particular mapping table entry, a database parameter 920 to indicate the name of the data source, a category parameter 922 to identify the categorical type (e.g., financial type information, volume type information, time-based information, etc.) of information stored by the data source, an owner parameter 924 to identify an owner of the data source, and a table parameter 926 and a column parameter 928 to identify a particular table and a column of the table within the data source in which the information corresponding to the mapped criterion is stored.

The normative mapped parameter portion 904 includes ‘mapped to’ parameters corresponding to the parameters 906, 910, 916, 918, 920, 922, 924, 926, and 928. For example, a mapped-to application ID 932 is mapped to the application ID 916 and indicates the ID of a normative application (e.g., the normative application 622 of FIG. 6) to which a native application is mapped. A mapped-to source ID 934 is mapped to the source ID 918 and indicates the ID of a normative data source (e.g., the normative data source 620 of FIG. 6). A mapped-to database parameter 936 is mapped to the database parameter 920 and indicates the name of a normative data source (e.g., the normative data source 620). A mapped-to category parameter 938 is mapped to the category parameter 922 and indicates the name of a normative categorical type.

FIG. 10 is an example mapping table data structure 1000 implemented in accordance with the example mapping table format 900 of FIG. 9. For simplicity of illustration, the example mapping table data structure 1000 includes three mapping entries 1002a-c. However, the example mapping table data structure 1000 shown in FIG. 10 may include any number of mapping entries. In the illustrated example, the mapping table data structure 1000 includes a ‘native database’ parameter value 1004 in a database column 1006 that is mapped to a ‘normative database’ parameter value 1008 in a mapped-to-database column 1010. The ‘native database’ parameter value 1004 may correspond to the native data source 612 of FIG. 6 and the ‘normative database’ parameter value 1008 may correspond to, for example, the normative (i.e., external) data source 620 of FIG. 6.

In the illustrated example, the mapping entries 1002a-c are used to map selection criteria associated with a time-based or period-based category as indicated by the period parameter 1012 stored in a category column 1014. The mapping entry 1002a is used to map a native database criterion ID ‘110505’ 1016 corresponding to a time period of Nov. 5, 2005 to a normative database criterion ID ‘1105’ 1018 corresponding to a time period of November 2005. In the illustrated example, the normative database stores data corresponding to a one-month time period (e.g., November 2005), but it does not store data corresponding to only a one-day time period (e.g., the one day time period of Nov. 5, 2005) as does the native database. Thus, the mapping entry 1002a is used to map the native database criterion ID ‘110505’ 1016 associated with the native database to the normative database criterion ID ‘1105’ 1018 associated with the normative database.

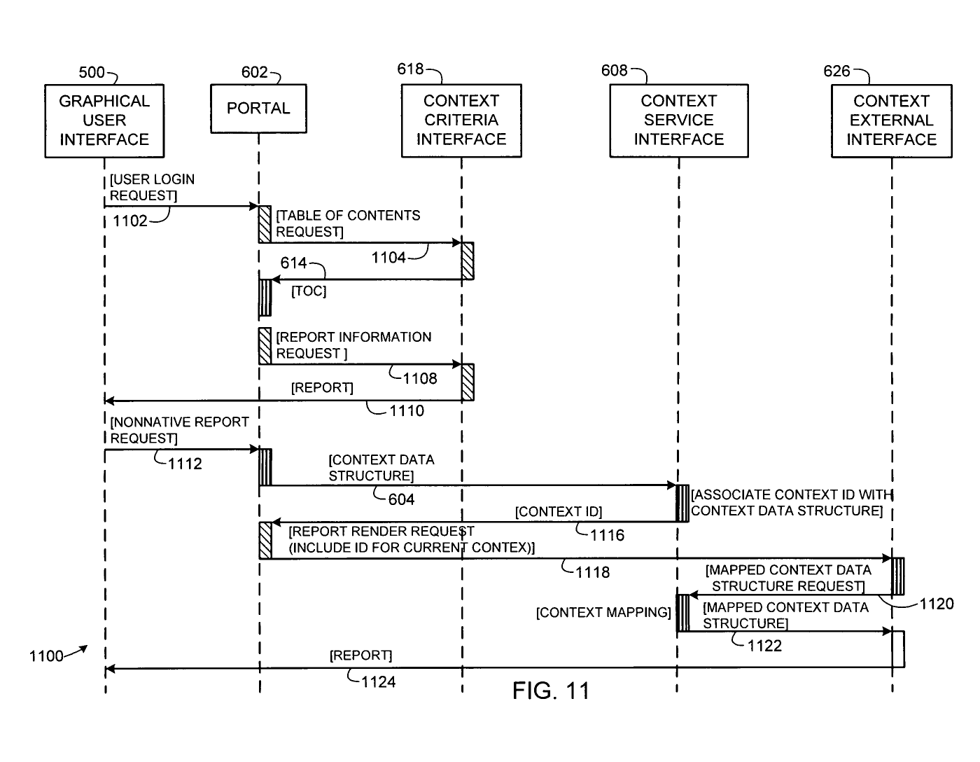

FIG. 12 is a flowchart representative of example machine readable instructions that may be executed by one or more entities of the example system 600 of FIG. 6 to enable the portal 602 of FIG. 6 to retrieve information (e.g., the report A information 502, the report B information 504, and/or the normative (i.e., external) report information 506 of FIG. 5) from a plurality of separate data sources (e.g., the native data source 612 and the normative (i.e., external) data source 620 of FIG. 6) without requiring a user to repeatedly provide selection criteria indicative of the information to be retrieved. Although the example machine readable instructions are described with reference to the flowchart of FIG. 12, other methods of implementing the example system 600 of FIG. 6 may additionally or alternatively be used. For example, the order of execution of the blocks depicted in the flowchart of FIG. 12 may be changed, and/or some of the blocks described may be rearranged, eliminated, or combined. Some of the operations of the flowchart of FIG. 12 described below are described in connection with an example timing diagram 1100 of FIG. 11 representative of example communication transactions between entities of the example system 600 of FIG. 6.

Turning in detail to FIG. 12, initially, the GUI 500 (FIG. 5) communicates a user login request 1102 (FIG. 11) to the portal 602 (block 1202). The portal 602 then communicates a TOC request 1104 (FIG. 11) to the context criteria interface 618 to, upon initial login, request a TOC (block 1204). For example, the user may set the portal 602 to always default to retrieving a TOC from a particular data structure or from a data structure that the user was working with during a previous login session. Thus, if the default data source is the native data source 612 (or if the user was working with the native data source 612 during a previous login session), the portal 602 may request the TOC 614 associated with the native data source 612 at block 1204. The portal 602 then receives the TOC 614 (FIG. 11) from the context criteria interface 618 (block 1206) and the portal 602 applies a default context or a current context (block 1208) based on the selection criteria in the TOC 614. For example, the portal 602 may use a default context if the user has set the portal 602 to, upon initial login, always default to a particular context (e.g., to particular selection criteria shown in the criterion selection fields 510a-c) or to a context that the user specified during a previous login session. Alternatively, the portal 602 may use a current context if the user, after an initial login, has specified particular selection criteria (e.g., selection criteria different from default selection criteria) via the criterion selection fields 510a-c.

The portal 602 then communicates a report information request 1108 (FIG. 11) to the context criteria interface 618 to request report information (block 1210). For example, the portal 602 may communicate the report information request 1108 in response to a user selecting one of the report selectors 514b-c of FIG. 5. The context criteria interface 618 then causes the report rendering engine 616 (FIG. 6) to communicate a report 1110 (FIG. 11) to the GUI 500 to render the report 1110 having the requested information (block 1212). For example, the report rendering engine 616 may generate the report 1110 to include the report A information 502 (FIG. 5).

The portal 202 then receives a normative (i.e., external) report request 1112 (FIG. 11) from the GUI 500 (block 1214). For example, the GUI 500 may communicate the normative report request 1112 to the portal 602 in response to a user selecting the report selector 514d of FIG. 5. The portal 602 then uses the context manager 606 to generate the context data structure 604 (FIG. 11) (block 1216) and the context service interface 608 associates a context ID 1116 (FIG. 11) with the context data structure 604 (block 1218). The portal 602 then communicates a report render request 1118 (FIG. 11) (which includes the context ID 1116) to the context external interface 626 to request the normative application 622 to render a report (block 1220). The context external interface 626 then communicates a context data structure request 1120 (FIG. 11) to the context service interface 608 to request a mapped context data structure (block 1222). In the illustrated example, the context data structure request 1120 includes the context ID 1116 to specify the context data structure 604 and to cause the context service interface 608 to map the selection criteria in the context data structure 604 to normative selection criteria in a mapped context data structure. In the illustrated example, the context service interface 608 uses the mapping table 624 of FIG. 6 to generate the mapped context data structure to include normative selection criteria mapped to the native selection criteria in the context data structure 604 as described above in connection with FIGS. 9 and 10.

The context service interface 608 then maps the context data structure 604 to the target application (block 1224). For example, context service interface 608 can map the native selection criteria in the context data structure 604 to normative selection criteria corresponding to the normative (i.e., external) application 622. The context service interface 608 then communicates a mapped context data structure 1122 (FIG. 11) to the context external interface 626 (block 1226), and the context external interface 626 causes the normative application 622 to communicate a report 1124 (FIG. 11) to the GUI 500 to render the report 1124 having the requested information (block 1228). For example, the normative application 622 may generate the report 1124 to include the normative report information 506 of FIG. 5. The process of FIG. 12 is then ended.

The example methods and apparatus described herein may be well suited for various business intelligence/logic systems and/or applications. In particular, the example methods and apparatus described herein may enable application reach-through for the ACNielsen Answers® platform, which is a system that, among other things, allows users to obtain and/or process information keyed-to the user's particular business needs. The Answers® platform may also allow the users to investigate causes of measured business results in view of key performance indicators.

FIG. 13 is a block diagram of an example processor system 1310 that may be used to execute the example machine readable instructions of FIGS. 4A, 4B, and 12 to implement the example systems, apparatus, and/or methods described herein. As shown in FIG. 13, the processor system 1310 includes a processor 1312 that is coupled to an interconnection bus 1314. The processor 1312 includes a register set or register space 1316, which is depicted in FIG. 13 as being entirely on-chip, but which could alternatively be located entirely or partially off-chip and directly coupled to the processor 1312 via dedicated electrical connections and/or via the interconnection bus 1314. The processor 1312 may be any suitable processor, processing unit or microprocessor. Although not shown in FIG. 13, the system 1310 may be a multi-processor system and, thus, may include one or more additional processors that are identical or similar to the processor 1312 and that are communicatively coupled to the interconnection bus 1314.

The processor 1312 of FIG. 13 is coupled to a chipset 1318, which includes a memory controller 1320 and an input/output (I/O) controller 1322. A chipset typically provides I/O and memory management functions as well as a plurality of general purpose and/or special purpose registers, timers, etc. that are accessible or used by one or more processors coupled to the chipset 1318. The memory controller 1320 performs functions that enable the processor 1312 (or processors if there are multiple processors) to access a system memory 1324 and a mass storage memory 1325.

The system memory 1324 may include any desired type of volatile and/or non-volatile memory such as, for example, static random access memory (SRAM), dynamic random access memory (DRAM), flash memory, read-only memory (ROM), etc. The mass storage memory 1325 may include any desired type of mass storage device including hard disk drives, optical drives, tape storage devices, etc.

The I/O controller 1322 performs functions that enable the processor 1312 to communicate with peripheral input/output (I/O) devices 1326 and 1328 and a network interface 1330 via an I/O bus 1332. The I/O devices 1326 and 1328 may be any desired type of I/O device such as, for example, a keyboard, a video display or monitor, a mouse, etc. The network interface 1330 may be, for example, an Ethernet device, an asynchronous transfer mode (ATM) device, an 802.11 device, a digital subscriber line (DSL) modem, a cable modem, a cellular modem, etc. that enables the processor system 1310 to communicate with another processor system.

While the memory controller 1320 and the I/O controller 1322 are depicted in FIG. 13 as separate functional blocks within the chipset 1318, the functions performed by these blocks may be integrated within a single semiconductor circuit or may be implemented using two or more separate integrated circuits.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method to invoke a business intelligence application comprising:
receiving a report request from a portal;
building context information based on the request;
generating context extensible markup language (XML) associated with the context information;
assigning a context identifier to the context XML; and
returning the context identifier to the portal for forwarding to the business intelligence application to initiate a service associated with the context information.

2. A method as defined in claim 1, wherein the context XML is generated by a context web server and stored in a data source.

3. A method as defined in claim 2, further comprising responding to a message from the business intelligence application referencing the context identifier by forwarding the context XML associated with the context identifier.

4. A method as defined in claim 3, further comprising translating the context XML to determine at least one command for the business intelligence application.

5. A method as defined in claim 4, wherein translating the context XML further comprises referencing at least one command library associated with the business intelligence application.

6. A method as defined in claim 1, wherein receiving the report request comprises receiving a globally unique identifier (GUID).

7. A method as defined in claim 6, further comprising searching for a matching GUID in a data source to determine at least some of the context information.

8. A method as defined in claim 1, wherein the context information comprises at least one of a market, a volume basis, a timeframe, a product line, a retailer, or report formatting information.

9. A method as defined in claim 1, further comprising receiving a result report from the business intelligence application, the report displayed in the portal in at least one of a formatted frame or an iFrame.

10. A method as defined in claim 9, wherein the iFrame displays the report with default formatting applied by the business intelligence application.

11. A method as defined in claim 9, further comprising an application interface to format the report generated by the business intelligence application based on the context information.

12-17. (canceled)

18. A system to invoke a business intelligence application comprising:
a portal to provide an indication of context information;
a reach through manager to associate the indication of context information with at least one of business intelligence application executable commands or formatting parameters; and
an application interface to facilitate communication between the reach through manager and the business intelligence application based on the indication of context information.

19. A system as defined in claim 18, wherein the reach through manager further comprises a context web server to generate context extensible markup language (XML) and associate a context identifier with the context XML.

20. A system as defined in claim 19, wherein the context web server forwards the context identifier to the portal.

21. A system as defined in claim 19, wherein the portal sends the context identifier to the application interface to invoke the business application.

22. A system as defined in claim 19, wherein at least one of the business intelligence application or the application interface return the context identifier to the reach through manager to obtain the context identifier.

23. A system as defined in claim 22, wherein the at least one application interface or business intelligence application return data to the portal based on the context information.

24. A system as defined in claim 23, wherein the portal displays the data in an iFrame.

25. A system as defined in claim 20, further comprising a data source, the application interface to receive the context identifier and query the data source to determine the business intelligence application executable command.

26. A system as defined in claim 25, wherein the data source further comprises at least one command library associated with the business intelligence application to provide a plurality of application commands.

27. A system as defined in claim 18, wherein the reach through manager further comprises a handler manager to determine a handler associated with the indication of context information.

28. A system as defined in claim 27, wherein the application interface translates the handler into the business intelligence application executable commands and generates an extensible markup language (XML) file indicative of output generated via execution of the commands by the business intelligence application.

29. A system as defined in claim 28, further comprising a rendering engine to format the output from the business intelligence application for presentation to the portal.

30-45. (canceled)

46. An article of manufacture storing machine accessible instructions that, when executed, cause a machine to:
receive a report request from a portal;
build context information based on the request;
generate context extensible markup language (XML) associated with the context information;
assign a context identifier to the context XML; and
return the context identifier to the portal for forwarding to the business intelligence application to initiate a service associated with the context information.

47. An article of manufacture as defined in claim 46, wherein the machine accessible instructions further cause the machine to generate the context XML via a context web server and store in a data source.

48. An article of manufacture as defined in claim 47, wherein the machine accessible instructions further cause the machine to respond to a message from the business intelligence application referencing the context identifier by forwarding the context XML associated with the context identifier.

49. An article of manufacture as defined in claim 48, wherein the machine accessible instructions further cause the machine to translate the context XML to determine at least one command for the business intelligence application.

50. An article of manufacture as defined in claim 49, wherein the machine accessible instructions further cause the machine to reference at least one command library associated with the business intelligence application.

51. An article of manufacture as defined in claim 46, wherein the machine accessible instructions further cause the machine to search for a matching globally unique identifier (GUID) in a data source to determine at least some of the context information.

52. An article of manufacture as defined in claim 46, wherein the machine accessible instructions further cause the machine to receive a result report from the business intelligence application, the report displayed in the portal in at least one of a formatted frame or an iFrame.

53. An article of manufacture as defined in claim 52, wherein the machine accessible instructions further cause the machine to display the report in the iFrame with default formatting applied by the business intelligence application.
